(19) United States
(12) Patent Application Publication
(10) Pub. No.: US 2026/0008642 A1
(43) Pub. Date: Jan. 8, 2026

(54) POST-PROCESSING DEVICE AND IMAGE FORMING APPARATUS

(71) Applicant: Konica Minolta, Inc., Tokyo (JP)

(72) Inventor: Riichi HAMA, Tokyo (JP)

(21) Appl. No.: 19/256,716

(22) Filed: Jul. 1, 2025

(30) Foreign Application Priority Data
Jul. 2, 2024 (JP) 2024-106957

(51) Int. Cl. B65H 29/00; B65H 31/34; B65H 37/00; G03G 15/00

(52) U.S. Cl. CPC B65H 29/003; B65H 31/34; B65H 37/00; G03G 15/6547; G03G 15/6552; B65H 2301/4222; B65H 2301/42242; B65H 2403/5321; B65H 2801/27

(57) ABSTRACT

A post-processing device includes an alignment section on which a plurality of recording media are stacked, a medium receiving section to which a plurality of recording media are discharged, a conveyance section that conveys a stack of a plurality of recording media stacked on the alignment section to the medium receiving section, and a single drive section that drives the conveyance section, wherein the conveyance section includes a gripping part that grips the plurality of recording media stacked on the alignment section, a gripping-part conveyance section that moves the gripping part in a state of gripping the plurality of recording media in a sheet ejection direction directed from the alignment section toward the medium receiving section, and a reciprocation mechanism that reciprocates the gripping-part conveyance section in a direction parallel to the sheet ejection direction.

### CROSS REFERENCE TO RELATED APPLICATIONS

The present invention claims priority under 35 U.S.C. § 119 to Japanese Patent Application No. 2024-106957 filed on Jul. 2, 2024, the entire content of which is incorporated herein by reference.

### BACKGROUND OF THE INVENTION

### Technical Field

The present invention relates to a post-processing device and an image forming apparatus. In particular, the present invention relates to a post-processing device that executes post-processing on a recording medium and an image forming apparatus including the post-processing device.

### Description of Related Art

A post-processing device may be attached to an image forming apparatus represented by a Multi-Function Peripheral (MFP). The post-processing device ejects, to a sheet ejection tray, a stack of a plurality of sheets on which image are formed by the MFP. The stack of the plurality of recording media to be ejected to the sheet ejection tray is preferably aligned.

For example, Japanese Patent No. 4774362 describes a sheet processing apparatus that includes a stacking means that temporarily receives a carried sheet member and stack the sheet member, a binding means that executes a binding process on a plurality of sheet members stacked on the stacking means, a first conveyance means that abuts against rear ends of the plurality of sheet members on which the binding process has been executed and conveys the sheet member to a receiving-transferring position, a second conveyance means that takes over conveyance from the first conveyance means at positions following the receiving-transferring position, and carries out the sheet member from the stacking means, a drive means that drives the first and second conveyance means using a rotational drive force of a single drive source, and a drive converting means that converts rotation movement of the drive means into linear reciprocation, wherein the drive converting means has a cam and a cam follower, and the first conveyance means is set in a stop state for a predetermined period of time at the receiving-transferring position depending on a shape of a contact portion in which the cam comes into contact with the cam follower.

However, in the sheet processing apparatus described in Japanese Patent No. 4774362, because the sheet member is transferred from the first conveyance means to the second conveyance means, the plurality of aligned sheet members may not be aligned at the time of transfer.

Further, Japanese Unexamined Patent Application Laid-Open No. 2011-006195 describes a sheet collection apparatus that is characterized in collecting sheets from a sheet ejection port in a stack at a predetermined position, and including the sheet ejection port, a tray means that collects sheets from the sheet ejection port, a sheet ejection means that moves sheets to a sheet end reference position on the tray means, a side alignment means that aligns a sheet ejection orthogonal direction of sheets sent by the sheet ejection means with a sheet side reference position, a gripper means that moves a sheet stack collected on the tray means, a grip conveyance drive means that moves the gripper means along the tray means, the sheet ejection means, and a control means that controls the side alignment means and the gripper means, wherein the gripper means includes a fixed gripper member that is engaged with a bottom sheet of the sheet stack, a mobile gripper member that is engaged with a top sheet, and a grip open-close drive means that openable and closable moves the mobile gripper member between a waiting position at which the gripper member is retreated from the top sheet and a grip position at which the gripper member is engaged with the top sheet.

However, the sheet stacking apparatus described in Japanese Unexamined Patent Publication No. 2011-6195 must use two drive sources which are a drive source for the gripper means and a drive source for the grip conveyance drive means and is required to execute control for synchronizing the gripper means with the grip conveyance drive means. Therefore, there is a problem that the process is complicated.

### SUMMARY OF THE INVENTION

According to one aspect of the present invention, a post-processing device includes an alignment section on which a plurality of recording media are stacked, a medium receiving section to which a plurality of recording media are discharged, a conveyance section that conveys a stack of a plurality of recording media stacked on the alignment section to the medium receiving section, and a single drive section that drives the conveyance section, wherein the conveyance section includes a gripping part that grips the plurality of recording media stacked on the alignment section, a gripping-part conveyance section that moves the gripping part in a state of gripping the plurality of recording media in a sheet ejection direction directed from the alignment section toward the medium receiving section, and a reciprocation mechanism that reciprocates the gripping-part conveyance section in a direction parallel to the sheet ejection direction.

According to another aspect of the present invention, an image forming apparatus includes the above-mentioned post-processing device.

### BRIEF DESCRIPTION OF THE DRAWINGS

The advantages and features provided by one or more embodiments of the invention will become more fully understood from the detailed description given hereinbelow and the appended drawings which are given by way of illustration only and thus are not intended as a definition of the limits of the present invention.

FIG. 1 is a first perspective view illustrating the appearance of an MFP in one embodiment of the present invention;

FIG. 2 is a cross-sectional view schematically illustrating one example of the inner configuration of the MFP;

FIG. 3 is a perspective view of a post-processing device in the present embodiment;

FIG. 4 is a perspective view illustrating one example of the inner configuration of the post-processing device in the present embodiment;

FIG. 5 is a side view illustrating one example of the inner configuration of the post-processing device in the present embodiment;

FIG. 6 is a first plan view illustrating one example of an alignment section of the post-processing device;

FIG. 7 is a first perspective view illustrating one example of a conveyance section;

FIG. 8 is a perspective view illustrating one example of a gripping-part conveyance section.

FIG. 9 is a first diagram illustrating one example of the positional relationship between a guide side plate and a gripping part;

FIG. 10 is a second diagram illustrating one example of the positional relationship between the guide side plate and the gripping part;

FIG. 11 is a second perspective view illustrating one example of the conveyance section;

FIG. 12 is a first side view of a swing drive mechanism;

FIG. 13 is a second side view of the swing drive mechanism;

FIG. 14 is a third side view of the swing drive mechanism;

FIG. 15 is a fourth side view of the swing drive mechanism;

FIG. 16 is a first diagram illustrating one example of the relationship between a position of the gripping-part conveyance section in a sheet ejection direction and a position of the gripping part in a circulation route;

FIG. 17 is a second diagram illustrating one example of the relationship between a position of the gripping-part conveyance section in the sheet ejection direction and a position of the gripping part in the circulation route;

FIG. 18 is a third diagram illustrating one example of the relationship between a position of the gripping-part conveyance section in the sheet ejection direction and a position of the gripping part in the circulation route;

FIG. 19 is a fourth diagram illustrating one example of the relationship between a position of the gripping-part conveyance section in the sheet ejection direction and a position of the gripping part in the circulation route;

FIG. 20 is a fifth diagram illustrating one example of the relationship between a position of the gripping-part conveyance section in the sheet ejection direction and a position of the gripping part in the circulation route;

FIG. 21 is a first side view illustrating one example of a gripping-part release mechanism; and

FIG. 22 is a second side view illustrating one example of the gripping-part release mechanism.

### DETAILED DESCRIPTION

Hereinafter, one or more embodiments of the present invention will be described with reference to the drawings. However, the scope of the invention is not limited to the disclosed embodiments.

Embodiments of the present invention will be described below with reference to the drawings. In the following description, the same components are denoted by the same reference numerals. Their names and functions are the same. Therefore, a detailed description thereof will not be repeated.

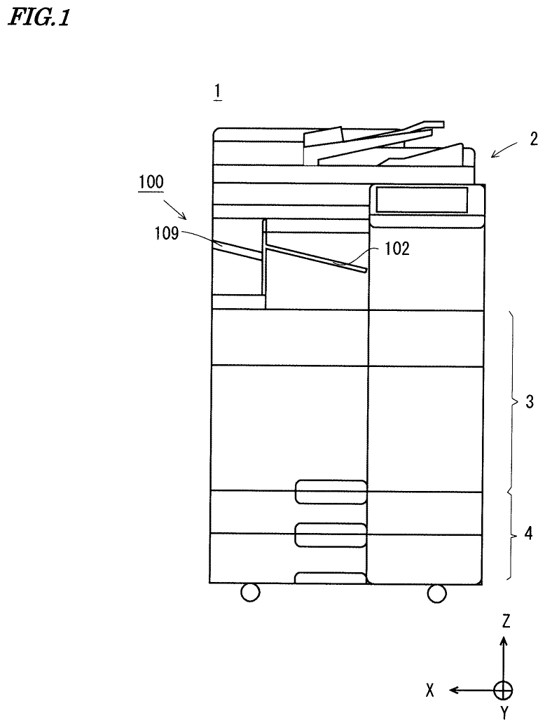

FIG. 1 is a first perspective view illustrating the appearance of an MFP in one embodiment of the present invention. With reference to FIG. 1, the Multi-Function Peripheral (MFP) 1 is one example of an image forming apparatus. Here, an X-direction, a Y-direction and a Z-direction which are orthogonal to one another are defined. The X direction and the Y direction are parallel to a horizontal plane. In the Y direction, a direction directed from a rear surface toward a front surface of the MFP 1 (a direction directed from a positive position toward a negative position in the Y direction) is referred to as a front-surface direction, and a horizontal direction directed from the front surface toward the rear surface (a direction directed from a negative position toward a positive position in the Y direction) is referred to as a rear-surface direction.

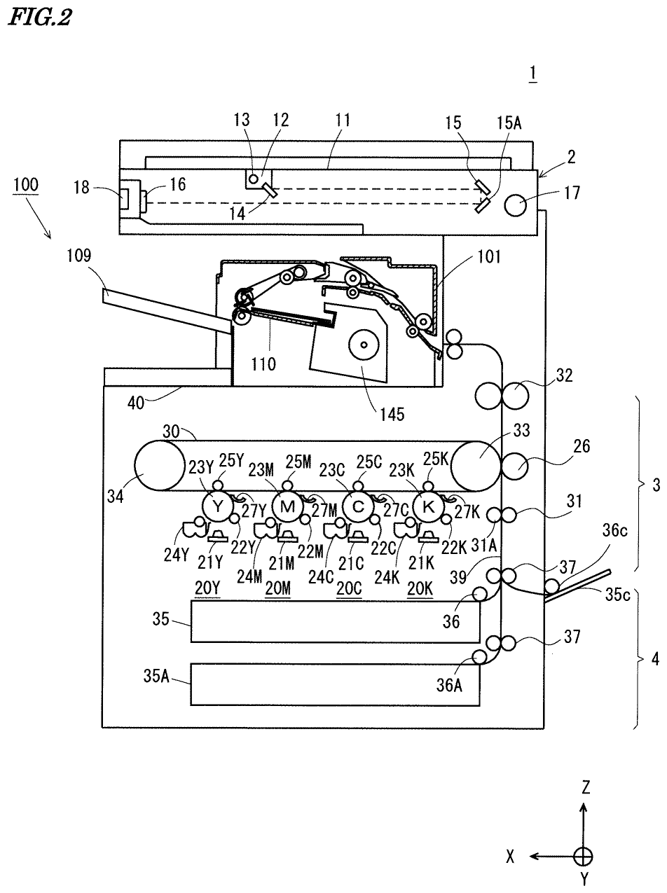

FIG. 2 is a cross-sectional view schematically illustrating one example of the inner configuration of the MFP. With reference to FIG. 1 and FIG. 2, the MFP 1 includes a document reading section 2 for reading a document, an image forming section 3 for forming an image on a sheet based on image data, a sheet feed section 4 for supplying a sheet to the image forming section 3 and a post-processing device 100 for executing post-processing on a sheet on which an image is formed.

The document reading section 2 exposes an image of a document set on a document glass 11 with an exposure lamp 13 attached to a slider 12 moving below the document glass 11. Light reflected from the document is guided to a lens 16 by a mirror 14 and two reflecting mirrors 15, 15A, and forms an image on a Charge Coupled Devices (CCD) sensor 18.

The reflected light that has formed an image on the CCD sensor 18 is converted into image data as an electric signal in the CCD sensor 18. The image data is converted into print data of cyan (C), magenta (M), yellow (Y) and black (K) and is output to the image forming section 3.

The image forming section 3 includes respective image forming units 20Y, 20M, 20C, 20K for respective yellow, magenta, cyan and black.

Here, “Y,” “M,” “C” and “K” represent yellow, magenta, cyan and black, respectively. An image is formed by driving of at least one of the image forming units 20Y, 20M, 20C, 20K. When all of the image forming units 20Y, 20M, 20C, 20K are driven, a full-color image is formed. Print data pieces for yellow, magenta, cyan and black are respectively input to the image forming units 20Y, 20M, 20C, 20K. The only difference among the image forming units 20Y, 20M, 20C, 20K is the colors of toners used by the image forming units 20Y, 20M, 20C, 20K. Therefore, the image forming unit 20Y for forming an image in yellow will be described here.

The image forming unit 20Y includes an exposure device 21Y, a photosensitive drum 23Y, a charging roller 22Y, a developing device 24Y and a primary transfer roller 25Y. Around the photosensitive drum 23Y, the charging roller 22Y, the exposure device 21Y, the developing device 24Y, the primary transfer roller 25Y and a drum cleaning blade 27Y are arranged in this order in a rotation direction of the photosensitive drum 23Y. The yellow print data piece is input to the exposure device 21Y. The photosensitive drum 23Y is an image bearing member. The charging roller 22Y uniformly charges the surface of the photosensitive drum 23Y. The primary transfer roller 25Y transfers a toner image formed on the photosensitive drum 23Y onto an intermediate transfer belt 30, serving as an image bearing member, using the effect of an electric field force.

After being electrically charged by the charging roller 22Y, the photosensitive drum 23Y is irradiated with laser light emitted by the exposure device 21Y. The exposure device 21Y exposes a portion corresponding to the image on the surface of the photosensitive drum 23Y. Thus, an electrostatic latent image is formed on the photosensitive drum 23Y. Subsequently, the developing device 24Y develops the electrostatic latent image formed on the photosensitive drum 23Y with the charged toner. Specifically, toner is placed on the electrostatic latent image formed on the photosensitive drum 23Y by the effect of an electric field force, so that the toner image is formed on the photosensitive drum 23Y. The toner image formed on the photosensitive drum 23Y is transferred onto the intermediate transfer belt 30 serving as an image bearing member by the primary transfer roller 25Y with use of the effect of an electric field force. The toner remaining on the photosensitive drum 23Y without being transferred is removed from the photosensitive drum 23Y by the drum cleaning blade 27Y.

The intermediate transfer belt 30 is suspended by a driving roller 33 and a driven roller 34 so as not to loosen. When the driving roller 33 is rotated in a counterclockwise direction in FIG. 2, the intermediate transfer belt 30 is rotated in the counterclockwise direction in the diagram at a predetermined speed. The driven roller 34 is rotated in the counterclockwise direction in accordance with rotation of the intermediate transfer belt 30.

Thus, the image forming units 20Y, 20M, 20C, 20K sequentially transfer toner images onto the intermediate transfer belt 30. Timing for transferring toner images onto the intermediate transfer belt 30 by the respective image forming units 20Y, 20M, 20C, 20K is adjusted based on detection of a reference mark provided on the intermediate transfer belt 30. Thus, toner images in yellow, magenta, cyan and black are superimposed on the intermediate transfer belt 30.

The toner images formed on the intermediate transfer belt 30 are transferred onto a sheet with the effect of an electric field force by a secondary transfer roller 26 serving as a transfer member. The sheet conveyed by a timing roller 31 is conveyed to a nip portion in which the intermediate transfer belt 30 and the secondary transfer roller 26 come into contact with each other. The sheet to which toner images are transferred is conveyed to a fixing roller 32 to be heated and pressurized by the fixing roller 32. Thus, the toner is fused and fixed to the sheet. Thereafter, the sheet is conveyed to the post-processing device 100.

In the sheet feed cassettes 35, 35A, sheets in different sizes are respectively set. The sheets respectively stored in the sheet feed cassettes 35, 35A are supplied to a conveyance route 39 by pickup rollers 36, 36A respectively attached to the sheet feed cassettes 35, 35A and are sent to the timing roller 31 by a sheet feed roller 37.

While driving all of the image forming units 20Y, 20M, 20C, 20K in a case of forming a full-color image, the MFP 1 drives any one of the image forming units 20Y, 20M, 20C, 20K in a case of forming a monochrome image. It is also possible to form an image by combining two or more of the image forming units 20Y, 20M, 20C, 20K. Here, the MFP 1 uses a tandem-system including the image forming units 20Y, 20M, 20C, 20K that respectively form toner images in four colors on a sheet, by way of example. However, the MFP 1 may use a four-cycle system that sequentially transfers the toner images in four colors onto a sheet using one photosensitive drum.

The post-processing device 100 is arranged in an accommodation space between the image forming section 3 and the document reading section 2 of the MFP 1. The post-processing device 100 is arranged on a slide surface 40, with the slide surface 40 being an upper surface of a top plate of a housing that accommodates the image forming section 3, so as to be slidable in the X direction.

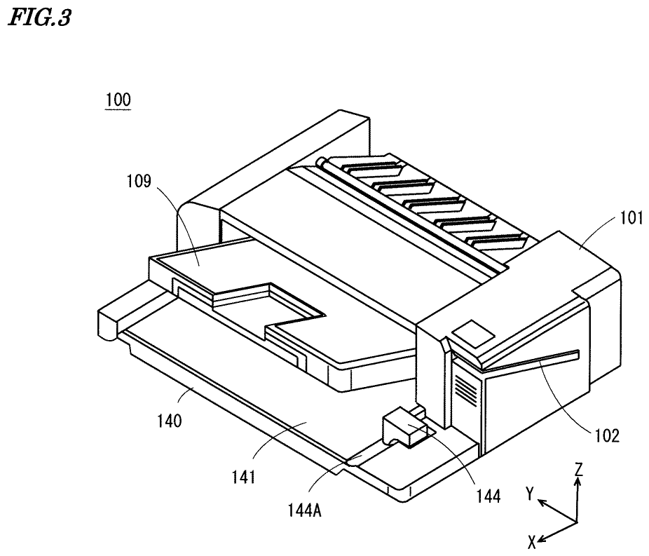

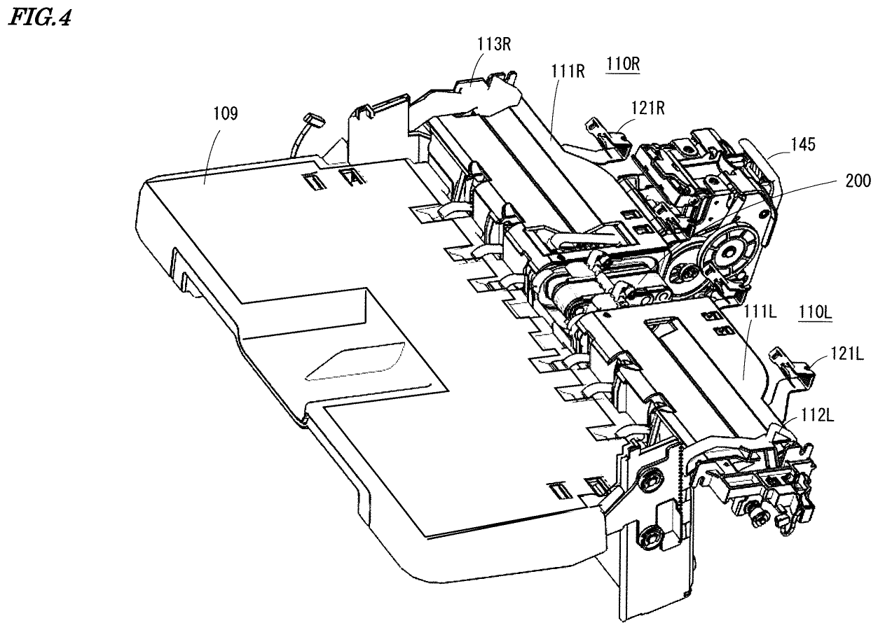

FIG. 3 is a perspective view of the post-processing device in the present embodiment. FIG. 4 is a perspective view illustrating one example of inner configuration of the post-processing device in the present embodiment. FIG. 5 is a side view illustrating one example of the inner configuration of the post-processing device in the present embodiment. With reference to FIG. 3 to FIG. 5, the post-processing device 100 has a main body housing 101. The main body housing 101 includes a main body rear portion 140 projecting in a positive X direction. The main body rear portion 140 is part of the main body housing 101 and includes part of a bottom surface 142 of the main body housing 101. The main body rear portion 140 has an operation surface 141 that faces upwardly and opposite to the bottom surface 142. In the operation surface 141A, a guide groove 144A extending in the X direction is formed. An operation part 144 is slidably attached to the guide groove 144A. The operation part 144 is attached to the operation surface 141 while being guided to the guide groove 144A and being slidable in the X direction. When a user slides the operation part 144 along the guide groove 144A, the post-processing device 100 slides in the X direction on the slide surface 40 and is brought into a state of being pulled out from the main body of the MFP 1.

The post-processing device 100 includes a sheet ejection tray 109 connected to the main body housing 101 above the main body rear portion 140. The post-processing device 100 includes a conveyance route 108, a receiving roller 105, a conveyance roller 106, an alignment section 110, a paddle 147, a conveyance section 200 and a stapler 145 in the main body housing 101. The conveyance route 108 is a route connecting a reception port 103 to a discharge port 104. The reception port 103 is an opening formed in a side surface opposite to a side surface to which the sheet ejection tray 109 of the main body housing 101 is connected. The reception port 103 is connected to the conveyance route 39 of the MFP 1. A direction directed from the reception port 103 toward the discharge port 104 is a conveyance direction in which a sheet is conveyed. On the conveyance route 108 between the reception port 103 and the discharge port 104, the receiving roller 105 and the conveyance roller 106 are arranged in this order in the conveyance direction. A sheet on which an image is formed by the MFP 1 passes through the conveyance route 39 of the MFP 1, and is received at the reception port 103 of the post-processing device 100. The sheet received at the reception port 103 is conveyed toward the conveyance roller 106 by the receiving roller 105. The sheet conveyed by the conveyance roller 106 is conveyed toward the discharge port 104.

The paddle 147 is arranged in a space farther downstream than the discharge port 104 in the conveyance direction of the sheet. The paddle 147 is movable in an upward-and-downward direction. During a period in which the sheet is conveyed on the conveyance route 108, the paddle 147 is located at an upper position, and a space located farther downstream than the discharge port 104 is formed. Therefore, the sheet conveyed by the conveyance roller 106 is conveyed toward the sheet ejection tray 109 with its tip oriented toward the sheet ejection tray 109, and the sheet is discharged to the space located farther downstream than the discharge port 104. When the rear end of the sheet conveyed by the conveyance roller 106 passes through the discharge port 104, the paddle 147 moves downwardly. As the paddle 147 is lowered, the sheet is lowered toward the alignment section 110. The paddle 147 is driven by a belt to rotate in the counterclockwise direction in the diagram. Thus, the sheet held between the paddle 147 and the alignment section 110 is conveyed in a direction opposite to the conveyance direction. On the alignment section 110, the sheet receives a force directed in a negative X direction by the paddle 147.

An insertion port 102 is formed at a position farther than the sheet ejection tray 109 of the main body housing 101 in the front-surface direction (negative Y direction). When the user inserts a first stack of a plurality of sheets into the insertion port 102, the first stack is stapled.

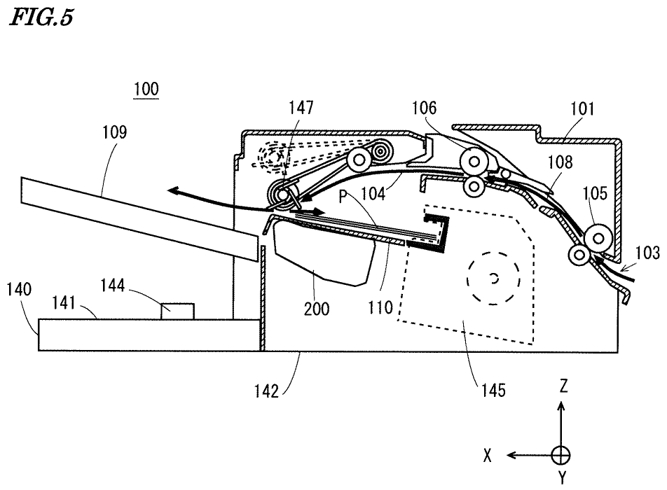

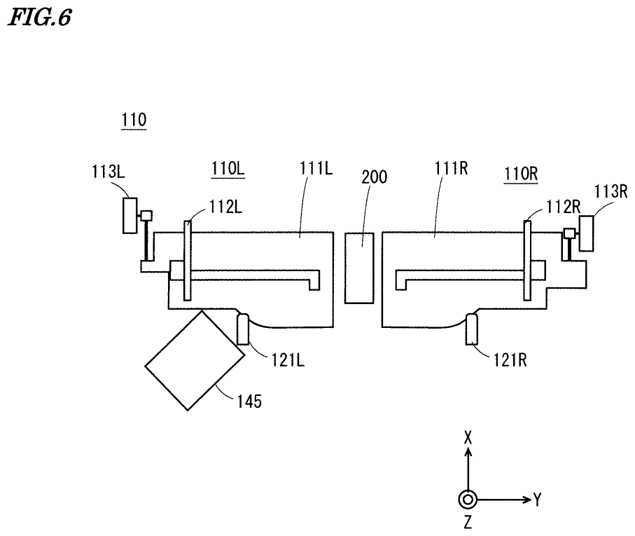

FIG. 6 is a first plan view illustrating one example of the alignment section of the post-processing device. With reference to FIG. 6, the alignment section 110 includes a first alignment section 110L and a second alignment section 110R that are arranged side by side at a predetermined interval in the Y direction. The first alignment section 110L and the second alignment section 110R have configurations that are symmetric with respect to an X-Z plane. Reference numerals provided to corresponding members of the first alignment section 110L and the second alignment section 110R include the same numerals. In order to distinguish a member of the first alignment section 110L from a member of the second alignment section 110R, an alphabet L is added to a reference numeral provided to a member of the first alignment section 110L, and an alphabet R is added to a reference numeral provided to a member of the second alignment section 110R.

The first alignment section 110L includes a placement plate 111L, a side restricting portion 112L, a drive motor 113L and an end-portion restricting portion 121L.

The placement plate 111L has a placement surface facing upwardly. A sheet is placed on the placement surface of the placement plate 111L. The end-portion restricting portion 121L is fixed to an end portion of the placement plate 111L located farther in the negative X direction. The end-portion restricting portion 121L has a restricting surface that faces in the positive X direction and is orthogonal to an upper surface of the placement plate 111L. A plurality of sheets stacked on the placement plate 111L receive a force directed in the negative X direction by the paddle 147. The plurality of sheets stacked on the placement plate 111L, abut against the restricting surface of the end-portion restricting portion 121L. The end-portion restricting portion 121L aligns the position of a second stack of a plurality of sheets in the negative X direction.

A side restricting portion 112L is arranged on the placement plate 111L, and a side restricting portion 112R is arranged on a placement plate 111R. The side restricting portion 112L and the side restricting portion 112R have alignment surfaces facing each other. The alignment surfaces are parallel to the X direction and the Z direction. The side restricting portion 112L moves in the Y direction by being driven by the drive motor 113L. The side restricting portion 112R moves in the Y direction by being driven by a drive motor 113R. By adjustment of the distance between the side restricting portion 112L and the side restricting portion 112R, the position in the Y direction of one or more sheets placed on the placement plate 111L and the placement plate 111R is defined.

Therefore, the position in the Y direction of the second stack of one or more sheets placed on the placement plate 111L and the placement plate 111R is defined by the end-portion restricting portion 121L and the end-portion restricting portion 121R on the placement plate 111L and the placement plate 111R.

The second stack the position of which in the X direction and the Y direction is defined on the placement plate 111L and the placement plate 111R is stapled by the stapler 145.

The conveyance section 200 is arranged between the placement plate 111L and the placement plate 111R. The conveyance section 200 discharges one or more sheets placed on the placement plate 111L and the placement plate 111R to the sheet ejection tray 109.

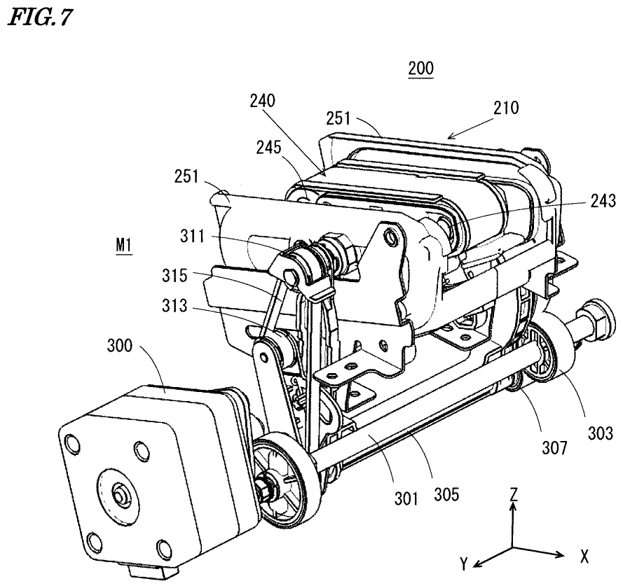

FIG. 7 is a first perspective view illustrating one example of the conveyance section. With reference to FIG. 7, the conveyance section 200 includes a gripping-part conveyance section 210 and a circulation drive mechanism M1. The gripping-part conveyance section 210 is attached to the main body housing 101 while being movable in a direction orthogonal to the Y direction and parallel to the placement surfaces of the placement plate 111L and the placement plate 111R. The circulation drive mechanism M1 includes a drive section 300, a first drive shaft 301 and a second drive shaft 305. The drive section 300 is a drive source, and is a motor, for example. The first drive shaft 301 has a rotation axis extending in parallel with the Y direction. The rotation axis of the first drive shaft 301 is rotatably supported at the main body housing 101. The first drive shaft 301 is connected to the drive section 300 via a gear and receives a driving force from the drive section 300 to rotate about the rotation axis. A first gear 303 is fixed to the first drive shaft 301.

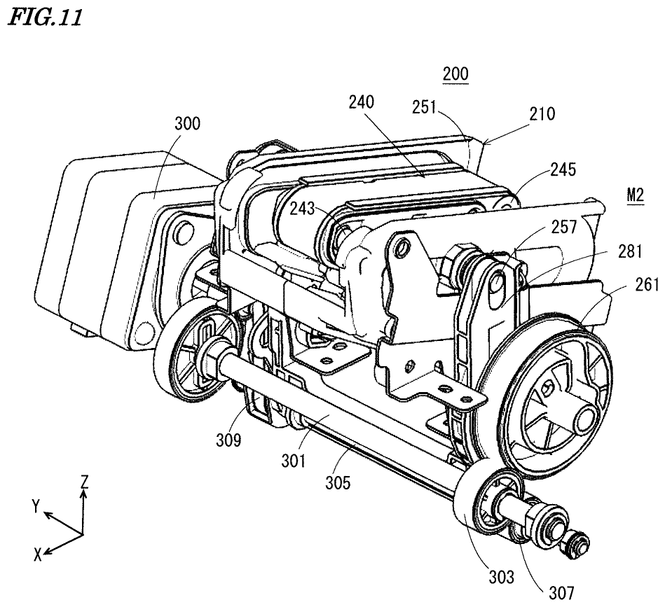

The second drive shaft 305 has a rotation axis extending in parallel with the Y direction. The rotation axis of the second drive shaft 305 is rotatably supported at the main body housing 101. A second gear 307 and a first pulley 309 (see FIG. 11) are fixed to the second drive shaft 305. The second gear 307 is engaged with the first gear 303. Therefore, the driving force of the drive section 300 is transmitted from the first drive shaft 301 to the second drive shaft 305 via the second gear 307 and the first gear 303, and the second drive shaft 305 rotates about the rotation axis.

The circulation drive mechanism M1 further includes a second pulley 311, an adjustment pulley 313 and a drive belt 315. The second pulley 311 is supported at a guide side plate 251 while being rotatable about its rotation axis. The drive belt 315 is suspended by the adjustment pulley 313, the second pulley 311 and the first pulley 309. The adjustment pulley 313 is biased by a spring or the like in an outward direction such that the drive belt 315 does not loosen. The first pulley 309 rotates with the rotation of the second drive shaft 305. The second pulley 311 and the adjustment pulley 313 rotate with the rotation of the first pulley 309. The second pulley 311 is connected to a driving roller 243 of a circulation conveyance section 240 via a gear. Therefore, a driving force of the drive section 300 is transmitted to the circulation conveyance section 240.

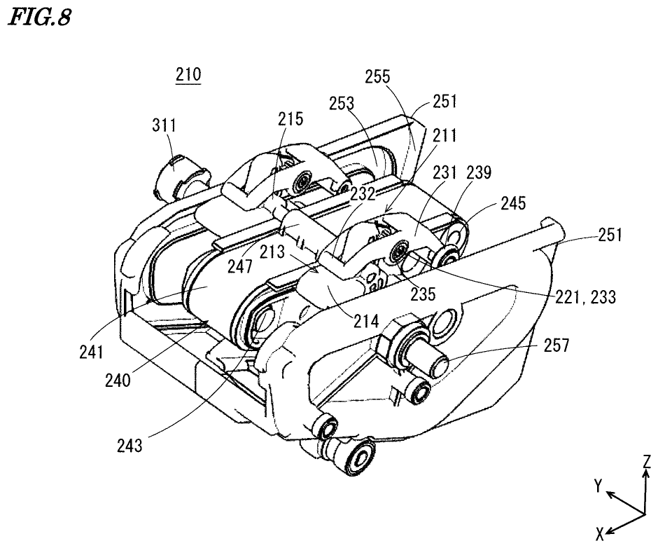

FIG. 8 is a perspective view illustrating one example of the gripping-part conveyance section. With reference to FIG. 8, the gripping-part conveyance section 210 includes a gripping part 211, the circulation conveyance section 240 and two guide side plates 251. The circulation conveyance section 240 is arranged between the two guide side plates 251. The gripping part 211 grips a plurality of sheets stacked on the placement plate 111L and the placement plate 111R. The gripping part 211 includes a base portion 213 and a mobile portion 231.

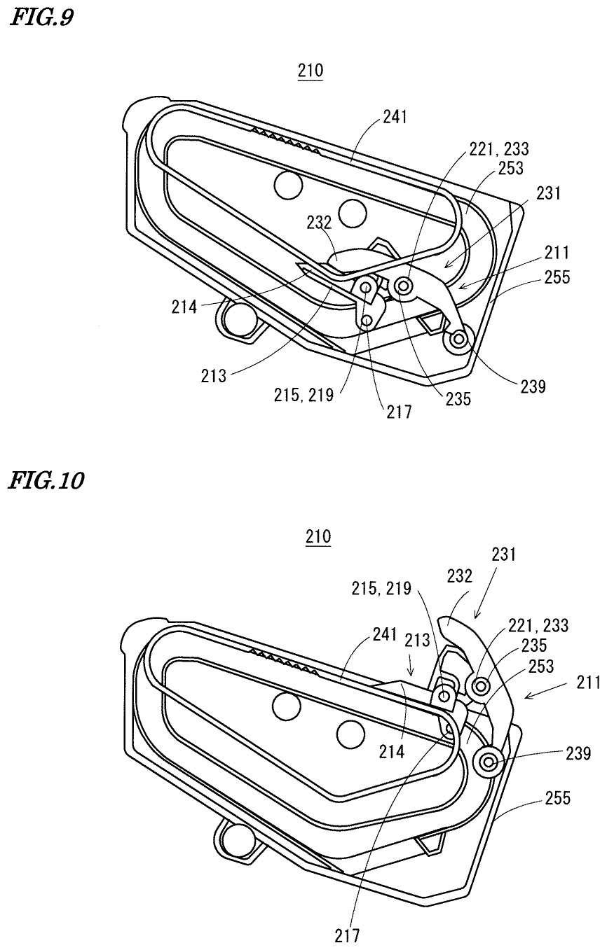

FIG. 9 is a first diagram illustrating one example of the positional relationship between the guide side plate and the gripping part. With reference to FIG. 8 and FIG. 9, the base portion 213 includes a lower holding part 214, a drive shaft 215, a base ring 217, a base biasing member 219 and a mobile bearing 221. The lower holding part 214 has a lower holding surface facing upwardly. The drive shaft 215 has a shape extending in parallel with the Y direction and is arranged at a position farther than the lower holding part 214 of the base portion 213 in the negative X direction.

The mobile portion 231 includes an upper holding part 232, a mobile shaft 233, a mobile biasing member 235, a mobile boss 237 and a slide ring 239. The mobile shaft 233 is axially supported by the mobile bearing 221 of the base portion 213. The mobile portion 231 is attached to the mobile shaft 233 while being rotatable about an axis of the mobile shaft 233. The upper holding part 232 has an upper holding surface, with the upper holding surface facing downwardly, at a position corresponding to the lower holding surface of the lower holding part 214. Therefore, when the mobile portion 231 rotates about the axis of the mobile shaft 233, the distance between the upper holding surface of the upper holding part 232 and the lower holding surface of the lower holding part 214 changes. The mobile portion 231 is biased by the mobile biasing member 235 in a direction toward the base portion 213. Therefore, while being in a state of not receiving a force from outside, the mobile portion 231 is biased by the mobile biasing member 235 and rotates about the axis of the mobile shaft 233 in a direction toward the base portion 213. In a case in which there is no sheet between the mobile portion 231 and the base portion 213, the mobile portion 231 comes into contact with the base portion 213. In a case in which a sheet is present between the mobile portion 231 and the base portion 213, the mobile portion 231 and the base portion 213 hold the sheet.

One of the two guide side plates 251, the circulation conveyance section 240 and the other guide side plate 251 are arranged in this order in the Y direction. The circulation conveyance section 240 includes an endless belt 241, a driving roller 243, a driven roller 245 and a drive bearing 247. Both ends of each of the driving roller 243 and the driven roller 245 are fixed to the two guide side plates 251 with the driving roller 243 and the driven roller 245 being arranged in the X direction with a predetermined distance therebetween and being rotatable about rotation axes extending in parallel with the Y direction. The endless belt 241 is suspended by the driving roller 243 and the driven roller 245 so as not to loosen. The driving roller 243 rotates by transmission of a driving force of the drive section 300, described below. The endless belt 241 and the driven roller 245 rotate with the rotation of the driving roller 243. The drive bearing 247 extending in the Y direction is fixed to the outer peripheral surface of the endless belt 241.

The drive bearing 247 axially supports the drive shaft 215 of the base portion 213. Therefore, with rotation of the endless belt 241, the base portion 213 moves along the outer periphery of the endless belt 241 suspended by the driving roller 243 and the driven roller 245. A trajectory along which the drive shaft 215 moves on the outer periphery of the endless belt 241 is referred to as a circulation route. In an upper straight portion of the circulation route, the drive shaft 215 moves in the positive X direction. The upper straight portion of the circulation route extends in parallel with the sheet ejection direction. In a lower portion of the circulation route, the drive shaft 215 moves in the negative X direction. The drive shaft 215 moves downwardly in a descending portion located farther in the positive X direction out of both end portions in which the straight portion and the lower portion are connected to each other. The drive shaft 215 moves upwardly in an ascending portion located farther in the negative X direction out of both end portions in which the straight portion and the lower portion are connected to each other.

During a period in which the drive shaft 215 moves in the upper straight portion of the circulation route, the circulation conveyance section 240 moves the gripping part 211 in a state of gripping a plurality of recording media in the sheet ejection direction (positive X direction) directed toward the sheet ejection tray 109 from the placement plate 111L and the placement plate 111R. Therefore, the circulation conveyance section 240 moves the gripping part 211 in a state of gripping the plurality of recording media in the sheet ejection direction directed toward the sheet ejection tray 109 from the placement plate 111L and the placement plate 111R.

The two guide side plates 251 are symmetrical with respect to the X-Z plane. Here, the guide side plate 251 provided at a position farther in the positive X direction will be described. In the guide side plate 251, a rail groove 253 and a guide surface 255 are formed at an inner side surface facing the other guide side plate 251, and a connection boss 257 extending in the Y direction is formed at an outer side surface opposite to the inner side surface.

In the base portion 213, the base ring 217 is provided opposite to the lower holding part 214 with respect to the drive shaft 215. The base ring 217 is biased by the base biasing member 219 in the counterclockwise direction and the positive Y direction about the drive shaft 215 in FIG. 9. Therefore, the base ring 217 is biased by the base biasing member 219 against a sidewall of the rail groove 253 formed at the guide side plate 251. In the base portion 213, the base ring 217 moves along the rail groove 253 formed in the guide side plate 251. The rail groove 253 is defined such that, the base portion 213 takes a posture in which the lower holding surface of the lower holding part 214 faces upwardly. In regard to the base portion 213, the drive shaft 215 moves along the circulation route. Therefore, during a period in which the gripping part 211 moves along the circulation route, the lower holding surface of the lower holding part 214 of the base portion 213 is kept facing upwardly.

The guide surface 255 is formed at an end portion of the guide side plate 251 located farther in the negative X direction. The guide surface 255 is a plane parallel to the Y direction and intersecting with the X direction and the Z direction. The guide surface 255 is arranged at a position separated from the rail groove 253 by a predetermined distance in the negative X direction. The slide ring 239 is attached to the mobile portion 231 on the side opposite to the upper holding part 232 with respect to the mobile shaft 233. The slide ring 239 is attached to the mobile portion 231 while being rotatable about the rotation shaft parallel to the Y direction.

In an abutment period that is part of a period in which the gripping part 211 moves in the ascending portion of the circulation route, the slide ring 239 abuts against the guide surface 255. During the abutment period, the base portion 213 keeps the posture in which the lower holding surface of the lower holding part 214 faces upwardly. The distance between the drive shaft 215 and the mobile shaft 233 is constant. Therefore, during the abutment period in which the drive shaft 215 moves along the circulation route, the mobile portion 231 overcomes a biasing force of the mobile biasing member 235 and rotates in a clockwise direction about the axis of the mobile shaft 233 in FIG. 9. Thus, the upper holding surface of the upper holding part 232 of the mobile portion 231 moves in a direction away from the lower holding surface of the lower holding part 214 of the base portion 213. At an abutment position at which the gripping part 211 abuts against the end portion located farther in the negative X direction of the plurality of sheets positioned on the placement plates 111L, 111R, the distance between the upper holding surface of the upper holding part 232 of the mobile portion 231 and the lower clamping surface of the lower holding part 214 of the base portion 213 is maximized.

FIG. 10 is a second diagram illustrating one example of the positional relationship between the guide side plate and the gripping part. FIG. 10 illustrates the gripping part 211 in a state of being located at the abutment position at which the gripping part 211 abuts against the end portion located farther in the negative X direction of the plurality of sheets positioned on the placement plates 111L, 111R. The upper holding surface of the upper holding part 232 of the mobile portion 231 is in a state of being separated from the lower holding surface of the lower holding part 214 of the base portion 213. The abutment position is an end portion located farther in the negative X direction of the upper straight portion of the circulation route. The abutment position may be the highest end of the ascending portion of the circulation route. Thus, the plurality of sheets can be located between the upper holding surface of the upper holding part 232 of the mobile portion 231 and the lower holding surface of the lower holding part 214 of the base portion 213. Further, when the drive shaft 215 moves in the sheet ejection direction in the upper straight portion of the circulation route, the slide ring 239 no longer abuts against the guide surface 255. When the slide ring 239 no longer abuts against the guide surface 255, the mobile portion 231 is biased by the mobile biasing member 235 in a direction toward the base portion 213. Thus, the plurality of sheets are gripped by the upper holding part 232 of the mobile portion 231 and the lower holding part 214 of the base portion 213.

During the abutment period, the distance between the guide surface 255 and the circulation route is adjusted such that the distance between the mobile shaft 233 and the guide surface 255 is shortened. At the abutment position, the distance between the guide surface 255 and the rail groove 253 is adjusted such that the distance between the upper holding surface of the upper holding part 232 of the mobile portion 231 and the lower holding surface of the lower holding part 214 of the base portion 213 is maximized.

FIG. 11 is a second perspective view illustrating one example of the conveyance section. With reference to FIG. 11, the conveyance section 200 further includes a swing drive mechanism M2. The swing drive mechanism M2 is arranged opposite to the circulation drive mechanism M1 with the gripping-part conveyance section 210 interposed therebetween. The swing drive mechanism M2 includes a crank gear 261 and a swing arm 281.

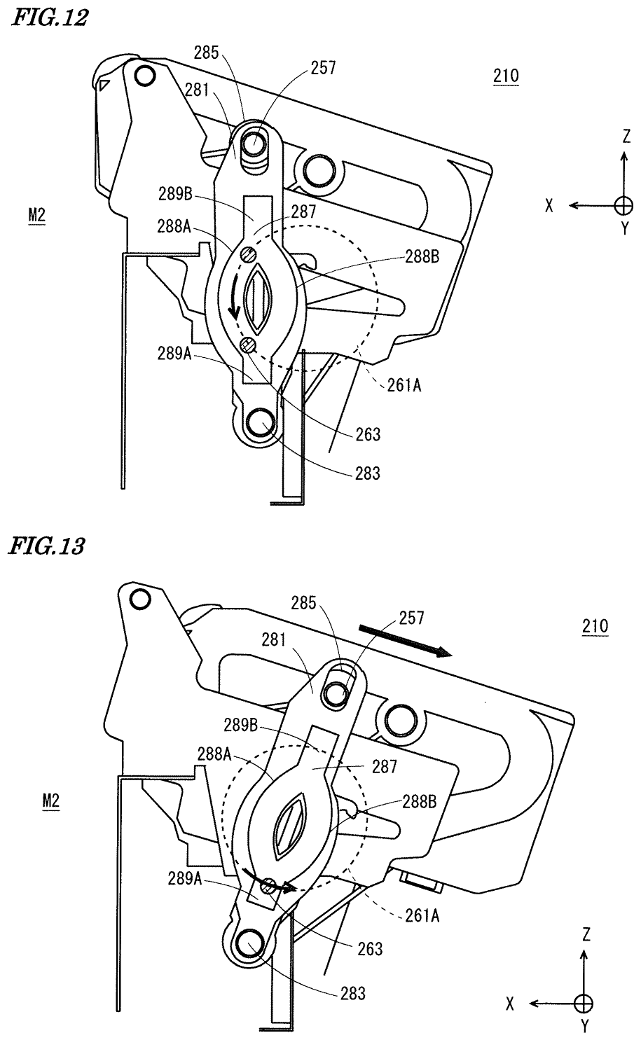

FIG. 12 is a first side view of the swing drive mechanism. With reference to FIG. 12, the swing arm 281 includes a base shaft 283, a connection groove 285 and a guide groove 287. The base shaft 283 has an axis extending in parallel with the Y direction and is rotatably fixed to the main body housing 101. The swing arm 281 is rotatable about an axis of the base shaft 283. The connection groove 285 of the swing arm 281 has a shape that extends in a radial direction with respect to the axis of the base shaft 283 and is a hole that penetrates in the Y direction. The connection boss 257 of the guide side plate 251 penetrates the connection groove 285 of the swing arm 281.

The crank gear 261 has a rotation shaft. The rotation shaft of the crank gear 261 is rotatably supported at the main body housing 101. The crank gear 261 has a gear formed at its outer periphery. The crank gear 261 is engaged with the first gear 303. Therefore, a driving force of the drive section 300 is transmitted to the crank gear 261 via the first drive shaft 301 and the first gear 303.

The crank gear 261 includes a crank boss 263 extending in parallel with the Y direction. The crank boss 263 is fitted to the guide groove 287 of the swing arm 281. The guide groove 287 includes a first arc portion 288A and a two second arc portion 288B, and a first straight portion 289A and a second straight portion 289B. The first arc portion 288A and the second arc portion 288B are arranged at positions opposite to each other, and the first straight portion 289A and the second straight portion 289B are arranged at positions opposite to each other. The first arc portion 288A and the second arc portion 288B are arranged between the first straight portion 289A and the second straight portion 289B. The first arc portion 288A and the second arc portion 288B are respectively connected to the first straight portion 289A and the second straight portion 289B. Each of the first arc portion 288A and the second arc portion 288B has a shape similar an arc-shaped area of the trajectory along which the crank boss 263 rotates. In other words, each of the first arc portion 288A and the second arc portion 288B has an arc shape having a radius equal to an orbit radius of the rotating crank boss. The center angle of each of the first arc portion 288A and the second arc portion 288B is smaller than 180 degrees. The center angle of each of the first arc portion 288A and the second arc portion 288B is defined based on the distance by which the circulation conveyance section 240 reciprocates in the direction parallel to the sheet ejection direction.

In FIG. 12, the rotation trajectory of the crank boss 263 is indicated by the dotted line. The rotation center of the crank boss 263 is the rotation center of the crank gear 261. The first straight portion 289A and the second straight portion 289B are arranged side by side in a direction in which a straight line passing through the base shaft 283 and orthogonal to the Y direction extends, and the two arc portions 288 are arranged between the first straight portion 289A and the second straight portion 289B.

FIG. 12 illustrates the crank boss 263 being located in the first arc portion 288A. The crank gear 261 rotates in the counterclockwise direction. During a period in which the crank boss 263 is located in the first arc portion 288A, the swing arm 281 does not rotate about the base shaft 283. Therefore, the gripping-part conveyance section does not move in a direction parallel to the sheet ejection direction. When the crank gear 261 further rotates, the crank boss 263 enters the first straight portion 289A.

FIG. 13 is a second side view of the swing drive mechanism. With the crank boss 263 located in the first straight portion 289A, the swing arm 281 rotates in the clockwise direction about the base shaft 283. As a result, the gripping-part conveyance section 210 moves in a direction opposite to the sheet ejection direction (the direction indicated by the arrow in FIG. 13). Further, when the crank gear 261 further rotates, the crank boss 263 enters the second arc portion 288B.

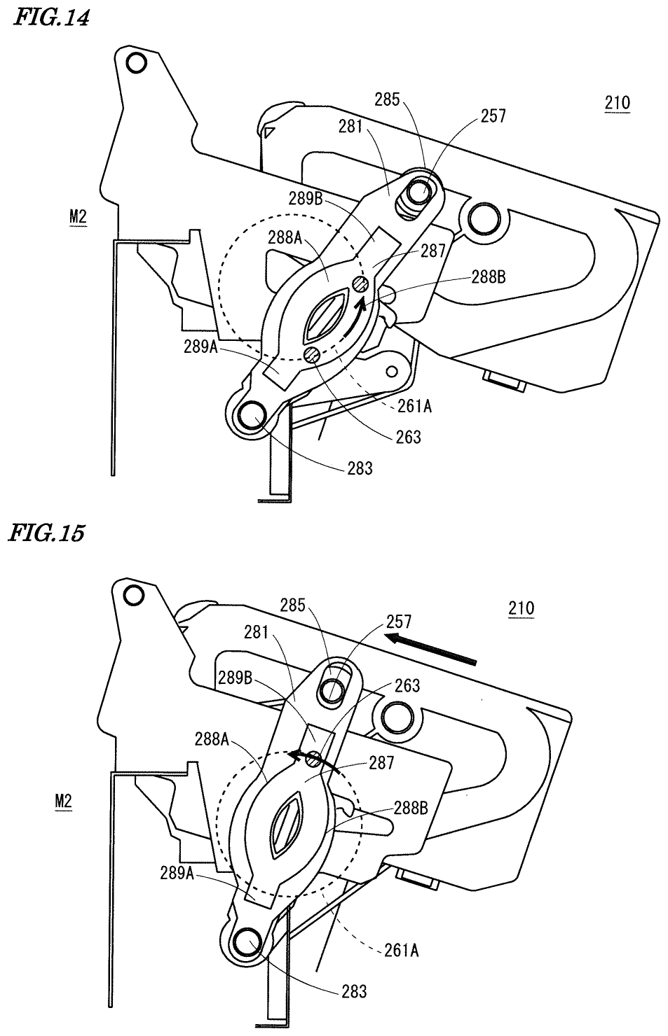

FIG. 14 is a third side view of the swing drive mechanism. During a period in which the crank boss 263 is located in the second arc portion 288B, the swing arm 281 does not rotate about the base shaft 283. Therefore, the gripping-part conveyance section 210 does not move in a direction parallel to the sheet ejection direction. When the crank gear 261 further rotates, the crank boss 263 enters the second straight portion 289B.

FIG. 15 is a fourth side view of the swing drive mechanism. With the crank boss 263 located in the second straight portion 289B, the swing arm 281 rotates in the counterclockwise direction about the base shaft 283. As a result, the gripping-part conveyance section 210 moves in the sheet ejection direction (the direction indicated by the arrow in FIG. 15).

In this manner, the circulation drive mechanism M1 and the swing drive mechanism M2 work by transmission of a driving force from the common drive section 300. The circulation drive mechanism M1 transmits a driving force of the drive section 300 to the gripping-part conveyance section 210. The gripping-part conveyance section 210 moves the gripping part 211 along the circulation route. In a case in which the gripping part 211 is located in the ascending portion of the circulation route, the gripping-part conveyance section 210 causes the gripping part 211 to grip the plurality of sheets. The gripping-part conveyance section 210 moves the gripping part 211 in the upper straight portion of the circulation route. In a case in which the gripping part 211 is located in the descending portion of the circulation route, the gripping-part conveyance section 210 causes the gripping part 211 to release the plurality of sheets. In a case in which the gripping part 211 is located in the lower portion of the circulation route, the gripping-part conveyance section 210 moves the gripping part 211 in the direction opposite to the sheet ejection direction.

The swing drive mechanism M2 causes the gripping-part conveyance section 210 to reciprocate in a direction parallel to the sheet ejection direction. The crank boss 263 provided in the crank gear 261 is fitted to the connection groove 285 formed in the swing arm 281, so that the swing drive mechanism M2 causes the swing arm 281 to rotate in the clockwise or counterclockwise direction about the axis of the base shaft 283. When the swing arm 281 rotates in the clockwise or counterclockwise direction about the axis of the base shaft 283, the swing arm 281 swings, and the gripping-part conveyance section 210 reciprocates in the direction parallel to the sheet ejection direction.

In the present embodiment, the drive section 300 synchronizes the movement of the gripping part 211 by the gripping-part conveyance section 210 with the reciprocation of the gripping-part conveyance section 210 by the swing drive mechanism M2. The drive section 300 drives the circulation drive mechanism M1 and the swing drive mechanism M2, and the swing drive mechanism M2 causes the gripping-part conveyance section 210 to reciprocate once during a period in which the gripping-part conveyance section 210 causes the gripping part 211 to circulate once along the circulation route. In this case, a position in the circulation route of the gripping part 211 that is conveyed along the circulation route by the gripping-part conveyance section 210 is synchronized with a position of the gripping-part conveyance section 210 that reciprocates in the direction parallel to the sheet ejection direction due to the swing arm 281. A rotation angle of the crank gear 261 and a position of the gripping part 211 in the circulation route are adjusted. A rotational angle of the crank gear 261 is defined based on a position of the crank boss 263.

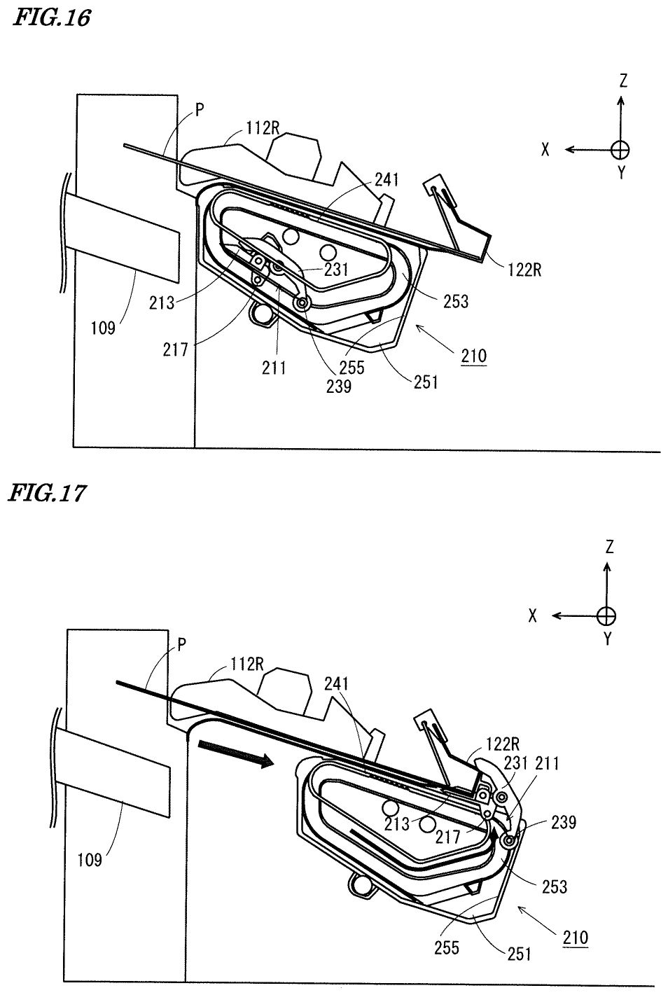

FIG. 16 is a first diagram illustrating one example of the relationship between a position of the gripping-part conveyance section in the sheet ejection direction and a position of the gripping part in the circulation route. FIG. 16 illustrates the gripping-part conveyance section 10 that has been moved to the farthest position in the sheet ejection direction. Further, the crank boss 263 of the crank gear 261 is located in the first arc portion 288A of the swing arm 281 and is in a state immediately before entering the first straight portion 289A. In this case, the gripping part 211 is located at a lower position in the circulation route extending along the endless belt 241. Further, in the gripping part 211, the upper holding surface of the mobile portion 231 and the lower holding surface of the base portion 213 are in contact with each other. The gripping part 211 moves in the direction opposite to the sheet ejection direction in the circulation route.

FIG. 17 is a second diagram illustrating one example of the relationship between a position of the gripping-part conveyance section in the sheet ejection direction and a position of the gripping part in the circulation route. FIG. 17 illustrates the gripping-part conveyance section 210 that has moved to the farthest position in the direction opposite to the sheet ejection direction. Further, the crank boss 263 of the crank gear 261 is located in the second arc portion 288B of the base shaft 283 of the swing arm 281 and is in a state immediately before entering the second straight portion 289B. In this case, the gripping part 211 is located in the ascending portion located farther in the negative X direction in the circulation route extending along the endless belt 241. Further, in the gripping part 211, the slide ring 239 of the mobile portion 231 abuts against the guide surface 255 of the guide side plate 251 and the upper holding surface of the mobile portion 231 is being located at a position farthest from the lower holding surface of the base portion 213. The mobile portion 231 moves in the sheet ejection direction. At a point in time at which the mobile shaft 233 of the mobile portion 231 is located at the end-portion restricting portion 121L, the slide ring 239 no longer abuts against the guide surface 255. As a result, the mobile portion 231 is biased by the mobile biasing member 235, and the mobile portion 231 moves in a direction such that the upper holding surface of the mobile portion 231 moves closer to the lower holding surface of the base portion 213. Thus, the gripping part 211 grips the one or more sheets placed on the placement plates 111L, 111R.

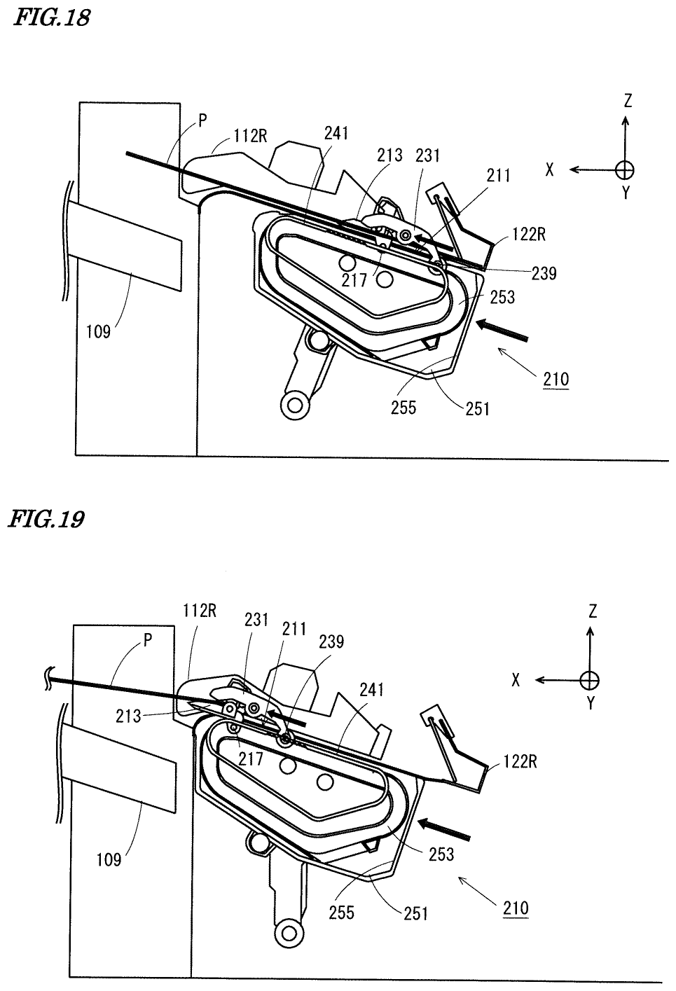

FIG. 18 is a third diagram illustrating one example of the relationship between a position of the gripping-part conveyance section in the sheet ejection direction and a position of the gripping part in the circulation route. FIG. 19 is a fourth diagram illustrating one example of the relationship between a position of the gripping-part conveyance section in the sheet ejection direction and a position of the gripping part in the circulation route.

As described above, the gripping-part conveyance section 210 moves reciprocates in the sheet ejection direction. FIG. 18 illustrates the gripping-part conveyance section being located at an end portion in the direction opposite to the sheet ejection direction on the trajectory along which the gripping-part conveyance section reciprocates. FIG. 19 illustrates the gripping-part conveyance section located at an end portion in the sheet ejection direction on the trajectory along which the gripping-part conveyance section reciprocates.

FIG. 18 and FIG. 19 illustrate the gripping part 211 being in the middle of moving in the sheet ejection direction in the upper portion of the circulation route. In FIG. 19, the gripping part 211 is located at a position closer to the sheet ejection tray 109 as compared to the position of the gripping part 211 illustrated in FIG. 18. That is, the gripping-part conveyance section 210 moves in the sheet ejection direction, and the gripping part 211 moves in the sheet ejection direction while gripping the one or more sheets placed on the placement plates 111L, 111R. Therefore, the one or more sheets are kept aligned during conveyance in the sheet ejection direction.

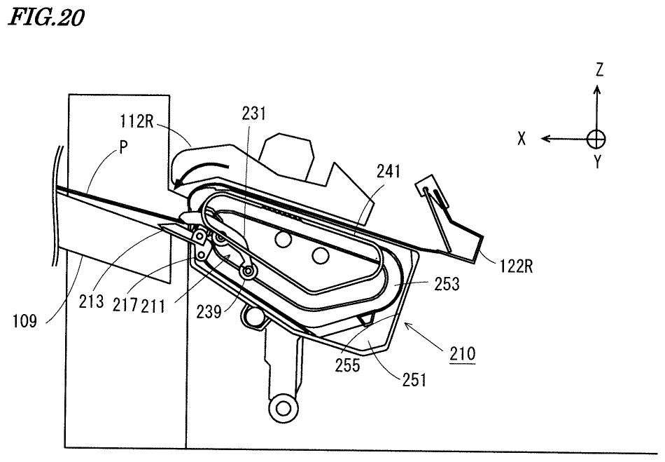

FIG. 20 is a fifth diagram illustrating one example of the relationship between a position of the gripping-part conveyance section in the sheet ejection direction and a position of the gripping part in the circulation route. In FIG. 20, the gripping part 211 is located at a descending portion located closest to the sheet ejection tray 109 in the circulation route. In the trajectory along which the gripping-part conveyance section 210 reciprocates, the gripping-part conveyance section 210 is stopped for a predetermined period of time at a position in an end portion located farther in the sheet ejection direction of the trajectory along which the gripping-part conveyance section 210 reciprocates in the sheet ejection direction. During a period in which the gripping-part conveyance section 210 is stopped at the end position located farther in the sheet ejection direction, the gripping part 211 moves from the upper straight portion to the lower portion in the descending portion of the circulation route. The gripping part 211 moves in the descending portion of the circulation route while gripping the one or more sheets. Therefore, the one or more sheets are placed on the sheet ejection tray 109 while being gripped by the gripping part 211.

During a period in which the gripping-part conveyance section 210 is stopped at the end portion located farther in the sheet ejection direction of the trajectory along which the gripping-part conveyance section 210 reciprocates, the gripping part 211 moves in the direction opposite to the sheet ejection direction to the middle of the lower portion of the circulation route. Thus, the gripping part 211 moves to the position illustrated in FIG. 16.

At a point in time at which the gripping part 211 has moved to the lowest end of the descending portion of the circulation route, the gripping part 211 is gripping the one or more sheets. In a release period during which the gripping part 211 moves in the direction opposite to the sheet ejection direction from a lower position of the circulation route to the position illustrated in FIG. 16 in the lower portion of the circulation route, the gripping part 211 releases the one or more sheets. Thus, the one or more sheets are placed on the sheet ejection tray 109 while being aligned.

The conveyance section 200 further includes a gripping-part release mechanism M3. FIG. 21 is a first side view illustrating one example of the gripping-part release mechanism. With reference to FIG. 21, the gripping-part release mechanism M3 includes a slide arm 271 and a coupling member 277. The slide arm 271 includes a slide shaft 273 and a slide boss 275. The slide shaft 273 has an axis extending in the Y direction and is rotatably supported at the main body housing 101. Therefore, the slide arm 271 is rotatable about the axis of the slide shaft 273. The slide boss 275 has a columnar shape extending in the Y direction and is fixed to the slide arm 271 at a position separated from the slide shaft 273 of the slide arm 271 by a predetermined distance. In the crank gear 261, a cam 265 is formed along the outer periphery of the crank gear 261. The slide arm 271 is biased by an elastic member such as a spring in a direction in which the slide boss 275 moves toward the cam 265 of the crank gear 261 (the clockwise direction in FIG. 21) about the axis of the slide shaft 273. Therefore, with the rotation of the crank gear 261, the slide arm 271 slides on the cam 265 of the crank gear 261 and is guided by the cam 265.

The slide arm 271 is connected to the coupling member 277 by a connection shaft 276 in a connection portion separated from the slide shaft 273 by a predetermined distance at a position opposite to the slide boss 275 with respect to the slide shaft 273. The slide arm 271 and the coupling member 277 are rotatable about an axis of the connection shaft 276.

In the coupling member 277, a coupling groove 279 is formed in an end portion located opposite to a portion connected to the connection shaft 276. The coupling groove 279 is a hole that penetrates the coupling member 277 in the Y direction. The mobile boss 237 of the mobile portion 231 is fitted to the coupling groove 279. The mobile boss 237 has a columnar shape extending in the Y direction and is fixed to the mobile portion 231 at a position separated from the mobile shaft 233 by a predetermined distance. The lengths of the coupling groove 279 in the X direction that intersects with the Y direction and the Y direction are larger than a diameter of the mobile boss 237. Therefore, the mobile boss 237 is slidable along an inner wall of the coupling groove 279.

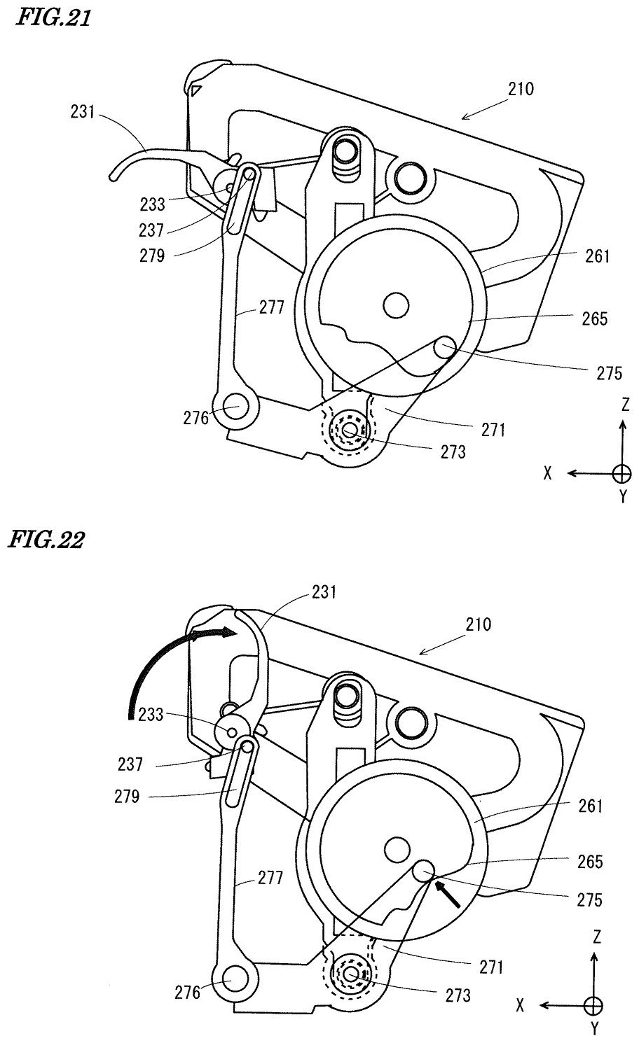

FIG. 22 is a second side view illustrating one example of the gripping-part release mechanism. With reference to FIG. 22, with the rotation of the crank gear 261, the slide boss 275 is pushed upwardly by the cam 265 formed at the crank gear 261. The slide arm 271 rotates in the counterclockwise direction about the axis of the slide shaft 273. As a result, the connection shaft 276 moves downwardly, so that the coupling groove 279 of the coupling member 277 moves downwardly. With the downward movement of the coupling groove 279, the mobile boss 237 of the mobile portion 231 moves downwardly. Thus, the mobile portion 231 rotates in the clockwise direction about the axis of the mobile shaft 233. Accordingly, the mobile portion 231 of the gripping part 211 moves in a direction away from the base portion 213.

The gripping-part release mechanism M3 moves the mobile portion 231 of the gripping part 211 in a direction away from the base portion 213 in the release period. In the release period, the gripping-part conveyance section 210 is located at an end portion located farther in the sheet ejection direction of the trajectory along which the gripping-part conveyance section 210 moves in parallel with the sheet ejection direction, and the gripping part 211 moves in the direction opposite to the sheet ejection direction in a lower portion of the circulation route. Therefore, after the one or more sheets are placed on the sheet ejection tray 109 while being aligned, the gripping part 211 no longer grips the one or more sheets and moves in the direction opposite to the sheet ejection direction.

### <Correspondence Between Constituent Elements in Claims and Elements in Embodiments>

The placement plates 111L, 111R in the present embodiment correspond to an alignment section in the claims, the sheet ejection tray 109 corresponds to a medium receiving section, the gripping-part conveyance section 210 corresponds to a conveyance section, and the drive section 300 corresponds to a drive section. Further, the gripping part 211 corresponds to a gripping part, the gripping-part conveyance section 210 corresponds to a gripping-part conveyance section, and the swing drive mechanism M2 corresponds to a reciprocation mechanism.

Further, the crank gear 261 corresponds to a crank gear, and the swing arm 281 corresponds to a coupling member. The base shaft 283 corresponds to a base shaft, the connection boss 257 corresponds to a connection boss, the connection groove 285 corresponds to a guide groove, and the first arc portion 288A and the second arc portion 288B corresponds to an arc-shaped portion.

The gripping part 211 corresponds to a gripping part, the base portion 213 corresponds to a base portion, the mobile portion 231 corresponds to a mobile portion, and the mobile biasing member 235 corresponds to a biasing member. The cam 265 corresponds to a cam formed in a circumferential direction of the crank gear, and the gripping-part release mechanism M3 corresponds to the gripping-part release mechanism.

The guide side plate 251 corresponds to a guide section, and the guide surface 255 corresponds to a guide surface that guides the mobile portion. The circulation conveyance section 240 corresponds to a circulation movement section. The rail groove 253 of the guide side plate 251 corresponds to a posture determining section.

The end-portion restricting portions 121L, 121R and the side restricting portions 112L, 112R correspond to a positioning section, and the stapler 145 corresponds to a processing section. The MFP 1 corresponds to an image forming apparatus.

### Overview of Embodiment

(Item 1) A post-processing device includes an alignment section on which a plurality of recording media are stacked, a medium receiving section to which a plurality of recording media are discharged, a conveyance section that conveys a stack of a plurality of recording media stacked on the alignment section to the medium receiving section, and a single drive section that drives the conveyance section, wherein the conveyance section includes a gripping part that grips the plurality of recording media stacked on the alignment section, a gripping-part conveyance section that moves the gripping part in a state of gripping the plurality of recording media in a sheet ejection direction directed from the alignment section toward the medium receiving section, and a reciprocation mechanism that reciprocates the gripping-part conveyance section in a direction parallel to the sheet ejection direction.

According to this aspect, because the gripping part in a state of gripping the plurality of recording media stack in the alignment section is moved, the plurality of recording media can be discharged to the medium receiving section while being aligned. Further, the gripping-part conveyance section, and the reciprocation mechanism that causes the gripping-part conveyance section to reciprocate are driven by a single drive section. Therefore, it is possible to reduce the number of components and reduce the cost and synchronize the gripping-part conveyance section with the reciprocation mechanism. As a result, it is possible to provide the post-processing device capable of discharging the plurality of aligned recording media while suppressing the cost.

(Item 2) The post-processing device according to item 1 further includes a crank gear to which a driving force is transmitted from the drive section, wherein the reciprocation mechanism includes a coupling member that is rotatably attached to a base shaft and is connected to a connection boss extending from the gripping-part conveyance section in the sheet ejection direction and a direction orthogonal to an upward-and-downward direction, in the coupling member, a guide groove that guides a crank boss provided in the crank gear is formed, and the guide groove has an arc-shaped portion having a radius equal to an orbit radius of the crank boss.

According to this aspect, during a period in which the crank boss is guided in the arc-shaped portion of the guide groove, the coupling member does not rotate about the base shaft. Therefore, it is possible to ensure a period during which the gripping-part conveyance section is stopped.

(Item 3) The post-processing device according to item 2, wherein the gripping part includes a base portion, a mobile portion having a variable distance from the base portion, and a biasing member that biases the mobile portion toward the base portion, and the post-processing device further includes a gripping-part release mechanism that is guided by a cam formed in a circumferential direction of the crank gear and moves the mobile portion in a direction away from the base portion.

According to this aspect, during a period in which the gripping-part conveyance section is stopped, the gripping part moves the mobile portion in a direction away from the base portion. Therefore, a force directed in a direction in which the gripping-part conveyance section reciprocates is not applied to a plurality of recording media gripped by the gripping part, and the gripping part is brought into a state of not gripping the plurality of recording media. Therefore, the plurality of recording media can be ejected while being kept aligned.

(Item 4) The post-processing device according to item 1, further includes a crank gear to which a driving force is transmitted from the drive section, wherein the gripping part includes a base portion, and a mobile portion having a variable distance from the base portion, and a biasing member that biases the mobile portion toward the base portion, and the post-processing device further includes a gripping-part release mechanism that is guided by a cam formed in a circumferential direction of the crank gear and moves the mobile portion in a direction away from the base portion.

According to this aspect, the mobile portion moves in a direction away from the base portion. Therefore, the drive section brings the gripping part into a state of not gripping the plurality of recording media. Therefore, the work for gripping the plurality of recording media and the work for releasing the plurality of recording media can be switched by a single drive section.

(Item 5) The post-processing device according to item 3 or 4, further includes a guide section that has a guide surface for guiding the mobile portion and is arranged at a position opposite to the medium receiving section with respect to the conveyance section and separated from the conveyance section by a predetermined distance.

According to this aspect, the mobile portion can be away from the defining section only during a period in which the mobile portion is in contact with the guide surface of a period in which the mobile portion is conveyed. Therefore, during a period in which the drive section conveys the gripping section, the mobile portion can work so as to be separated from the defining section before the gripping part grips the plurality of recording media.

(Item 6) The post-processing device according to any one of items 1 to 5, wherein the gripping-part conveyance section includes a circulation movement section that causes the gripping part to circulate along a circulation route, and during a period in which the gripping-part conveyance section causes the gripping part to circulate once along the circulation route, the reciprocation mechanism causes the gripping-part conveyance section to reciprocate once.

According to this aspect, during a period in which driving the gripping-part conveyance section and causing the gripping part to circulate once along the circulation route, the drive section drives the reciprocation mechanism and causes the gripping-part conveyance section to reciprocate once along the circulation route. Therefore, it is possible to synchronize the movement of the gripping part with the movement of the gripping-part conveyance section.

(Item 7) The post-processing device according to item 6, wherein during a period in which moving along the circulation route, the gripping part abuts against upstream end portions in the sheet ejection direction of a plurality of recording media positioned on the alignment plate.

According to this aspect, during a period in which moving along the circulation route, the gripping part abuts against an upstream end portion in the sheet ejection direction of the plurality of recording media positioned on the alignment section. Therefore, it is possible to convey the plurality of recording media in the sheet ejection direction by pushing the plurality of recording media in the conveyance direction.

(Item 8) The post-processing device according to item 6, wherein the gripping-part conveyance section includes a posture determining section that determines a posture of the gripping part in the circulation route.

According to this aspect, because the posture of the gripping part in the circulation route is determined, it is possible to cause the gripping part to accurately grip the plurality of recording media.

(Item 9) The post-processing apparatus according to any one of items 1 to 5, further includes a positioning section that positions the plurality of recording media stacked on the alignment section with respect to the alignment section, and a processing section that processes the plurality of recording media positioned by the positioning section.

According to this aspect, because the plurality of recording media placed on the alignment section are aligned, the plurality of recording media can be processed at an accurate position.

(Item 10) An image forming apparatus includes the post-processing device according to any one of items 1 to 9.

It should be understood that the embodiments disclosed herein are illustrative and non-restrictive in every respect. The scope of the present invention is defined not by the above description but by the appended claims and is intended to include any modifications within the scope and meaning equivalent to the appended claims.

Although embodiments of the present invention have been described and illustrated in detail, the disclosed embodiments are made for the purpose of illustration and example only and not limitation. The scope of the present invention should be interpreted by terms of the appended claims.

What is claimed is:

1. A post-processing device comprising:
an alignment section on which a plurality of recording media are stacked;
a medium receiving section to which a plurality of recording media are discharged;
a conveyance section that conveys a stack of a plurality of recording media stacked on the alignment section to the medium receiving section; and
a single drive section that drives the conveyance section, wherein
the conveyance section includes
a gripping part that grips the plurality of recording media stacked on the alignment section,
a gripping-part conveyance section that moves the gripping part in a state of gripping the plurality of recording media in a sheet ejection direction directed from the alignment section toward the medium receiving section, and
a reciprocation mechanism that reciprocates the gripping-part conveyance section in a direction parallel to the sheet ejection direction.

2. The post-processing device according to claim 1, further comprising a crank gear to which a driving force is transmitted from the drive section, wherein
the reciprocation mechanism includes a coupling member that is rotatably attached to a base shaft and is connected to a connection boss extending from the gripping-part conveyance section in the sheet ejection direction and a direction orthogonal to an upward-and-downward direction,
in the coupling member, a guide groove that guides a crank boss provided in the crank gear is formed, and
the guide groove has an arc-shaped portion having a radius equal to an orbit radius of the crank boss.

3. The post-processing device according to claim 2, wherein
the gripping part includes
a base portion,
a mobile portion having a variable distance from the base portion, and
a biasing member that biases the mobile portion toward the base portion, and
the post-processing device further includes a gripping-part release mechanism that is guided by a cam formed in a circumferential direction of the crank gear and moves the mobile portion in a direction away from the base portion.

4. The post-processing device according to claim 1, further comprising a crank gear to which a driving force is transmitted from the drive section, wherein
the gripping part includes
a base portion, and a mobile portion having a variable distance from the base portion, and
a biasing member that biases the mobile portion toward the base portion, and
the post-processing device further includes a gripping-part release mechanism that is guided by a cam formed in a circumferential direction of the crank gear and moves the mobile portion in a direction away from the base portion.

5. The post-processing device according to claim 4, further comprising a guide section that has a guide surface for guiding the mobile portion and is arranged at a position opposite to the medium receiving section with respect to the conveyance section and separated from the conveyance section by a predetermined distance.

6. The post-processing device according to claim 1, wherein
the gripping-part conveyance section includes a circulation movement section that causes the gripping part to circulate along a circulation route, and
during a period in which the gripping-part conveyance section causes the gripping part to circulate once along the circulation route, the reciprocation mechanism causes the gripping-part conveyance section to reciprocate once.

7. The post-processing device according to claim 6, wherein
during a period in which moving along the circulation route, the gripping part abuts against upstream end portions in the sheet ejection direction of a plurality of recording media positioned on the alignment plate.

8. The post-processing device according to claim 6, wherein
the gripping-part conveyance section includes a posture determining section that determines a posture of the gripping part in the circulation route.

9. The post-processing apparatus according to claim 1, further comprising:
a positioning section that positions the plurality of recording media stacked on the alignment section with respect to the alignment section; and
a processing section that processes the plurality of recording media positioned by the positioning section.

10. An image forming apparatus comprising the post-processing device according to claim 1.
